(19) United States
(12) Patent Application Publication
(10) Pub. No.: US 2020/0183312 A1
(43) Pub. Date: Jun. 11, 2020

(54) IMAGE FORMING APPARATUS, METHOD FOR CONTROLLING IMAGE FORMING APPARATUS, AND PROGRAM

(71) Applicant: KONICA MINOLTA, INC., Tokyo (JP)

(72) Inventor: Daiki Yamanaka, Sagamihara-shi (JP)

(73) Assignee: KONICA MINOLTA, INC., Tokyo (JP)

(21) Appl. No.: 16/666,722

(22) Filed: Oct. 29, 2019

(30) Foreign Application Priority Data
Dec. 6, 2018 (JP) 2018-229013

(51) Int. Cl. G03G 15/00; G03G 15/10

(52) U.S. Cl. CPC G03G 15/5041; G03G 2215/00037; G03G 15/105

(57) ABSTRACT

An image forming apparatus includes: a plurality of image forming parts each of which transfers a toner image to the transfer medium, the plurality of image forming parts being arranged from an upstream side to a downstream side along a moving direction of the transfer medium; a density detector that detects a density of the toner image; and a hardware processor that performs image stabilization control in which a plurality of patch images is formed while levels of parameters of image formation are changed for each of the image forming parts and the parameters are corrected based on respective densities of the patch images detected by the density detector.

The entire disclosure of Japanese patent Application No. 2018-229013, filed on Dec. 6, 2018, is incorporated herein by reference in its entirety.

### BACKGROUND

### Technological Field

The present invention relates to an image forming apparatus, a method for controlling an image forming apparatus, and a program.

### Description of the Related Art

In an image forming apparatus using an electrophotographic process, a photosensitive drum is charged by a charging device, and laser light is applied based on image data, so that an electrostatic latent image is formed on the photosensitive drum. A developing device supplies developer to the photosensitive drum to visualize the electrostatic latent image. As a result, an image (toner image) is formed on the photosensitive drum. The image formed on the photosensitive drum is transferred to a paper sheet via an intermediate transfer belt. The transferred image is then fixed. As a result, the image is formed on the paper sheet. This sort of image forming apparatus is known to have a configuration in which a plurality of image forming parts is arranged from the upstream side to the downstream side along the running direction (moving direction) of the intermediate transfer belt as a transfer medium.

In the image forming apparatus, image stabilization control is performed at an appropriate timing. In the image stabilization control, a plurality of patch images is formed on the intermediate transfer belt while the levels of parameters of image formation are changed, and the density (toner adhesion amount) of each patch image is detected. Then, the parameters are corrected based on the toner adhesion amounts (hereinafter referred to as “image densities”) of the patch images. As a result of the correction, development characteristics are optimized, so that image density can be stabilized. Parameters of image formation include development potential, charge potential, and the like. For example, JP 2009-300901 A and JP 2006-220848 A disclose image forming apparatuses capable of stabilizing image quality.

Incidentally, when a patch image formed in an upstream image forming part passes through a downstream image forming part, there occurs a phenomenon (reverse transfer) in which toner is transferred to the photosensitive drum. The amount of reverse transfer is correlated with charge potential. Therefore, if the charge potential is corrected, the amount of reverse transfer changes due to a difference between charge potentials of the downstream image forming part. Thus, there is a problem that correct development characteristics cannot be obtained and correction accuracy deteriorates.

### SUMMARY

The present invention has been made in view of such circumstances, and an object of the present invention is to provide an image forming apparatus, a method for controlling an image forming apparatus, and a program capable of achieving both reduction of correction time and improvement of correction accuracy.

To achieve the abovementioned object, according to an aspect of the present invention, there is provided an image forming apparatus in which an image carrier with a charged surface is developed with toner to cause a toner image to be carried on the image carrier and the toner image is transferred from the image carrier to a transfer medium, and the image forming apparatus reflecting one aspect of the present invention comprises: a plurality of image forming parts each of which transfers a toner image to the transfer medium, the plurality of image forming parts being arranged from an upstream side to a downstream side along a moving direction of the transfer medium; a density detector that detects a density of the toner image; and a hardware processor that performs image stabilization control in which a plurality of patch images is formed while levels of parameters of image formation are changed for each of the image forming parts and the parameters are corrected based on respective densities of the patch images detected by the density detector, wherein the parameters include a charge potential, and in the image stabilization control, a level of charge potential in a downstream image forming part is changed in such order that weighted averages of charge potentials in the downstream image forming part are discrete with respect to order in which a level of charge potential is changed in a upstream image forming part.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a configuration diagram schematically showing an image forming apparatus according to the present embodiment;

FIG. 2 is an explanatory diagram describing reverse transfer;

FIG. 3 is a diagram showing development characteristics of an image forming part;

FIGS. 4A and 4B are explanatory diagrams describing correction of development characteristics;

FIG. 5 is an explanatory diagram describing transitions of patch images formed on an intermediate transfer belt;

FIGS. 6A and 6B are explanatory diagrams showing discrete relationships;

FIG. 7 is an explanatory diagram showing a concept of calculating a reverse transfer amount from an approximate expression;

FIG. 8 is an explanatory diagram showing a concept of calculating a reverse transfer amount from measurement; and

FIG. 9 is a flowchart showing the flow of a process to be performed by the image forming apparatus.

### DETAILED DESCRIPTION OF EMBODIMENTS

Hereinafter, one or more embodiments of the present invention will be described with reference to the drawings. However, the scope of the invention is not limited to the disclosed embodiments.

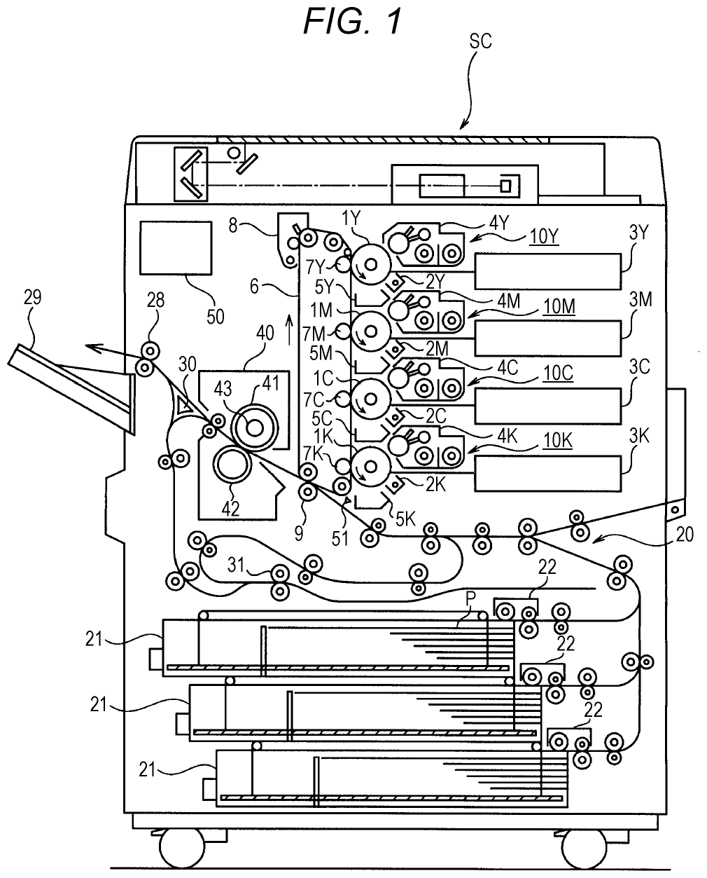

FIG. 1 is a configuration diagram schematically showing an image forming apparatus according to the present embodiment. This image forming apparatus uses an electrophotographic process. Specifically, the image forming apparatus includes a plurality of photosensitive drums facing a single intermediate transfer belt and arranged from the upstream side to the downstream side along the moving direction (running direction) of the intermediate transfer belt. The image forming apparatus is a so-called tandem-type color image forming apparatus that forms a full-color image based on the configuration described above.

The image forming apparatus mainly includes a document reading device SC, a plurality of image forming parts 10Y, 10M, 10C, and 10K, a fixing device 40, and a controller 50, which are stored in a single housing.

The document reading device SC scans and exposes a document image with the optical system of a scanning exposure device, and reads reflected light therefrom with a line image sensor. The document reading device SC thus obtains an image signal. The image signal is subjected to processing such as analog-digital (A/D) conversion, shading correction, and compression, and then input to the controller 50, as image data. Note that the image data to be input to the controller 50 are not limited to data read by the document reading device SC, but may be, for example, data received from a personal computer or another image forming apparatus connected to the image forming apparatus, or data read from a portable recording medium such as a USB flash drive.

In the present embodiment, the image forming parts 10Y, 10M, 10C, and 10K correspond to an image forming part that forms a yellow (Y) image, an image forming part that forms a magenta (M) image, an image forming part that forms a cyan (C) image, and an image forming part that forms a black (K) image, respectively. The four image forming parts 10Y, 10M, 10C, and 10K are arranged from the upstream side to the downstream side along the moving direction (running direction) of an intermediate transfer belt 6 while facing the intermediate transfer belt 6. Of the four image forming parts 10Y, 10M, 10C, and 10K, the yellow image forming part 10Y is located most upstream, and the magenta image forming part 10M and the cyan image forming part 10C are arranged downstream in this order. The black image forming part 10K is located most downstream.

The image forming part 10Y includes a photosensitive drum 1Y, and also includes a charging part 2Y, an optical writing part 3Y, a developing device 4Y, a cleaning device 5Y, and a primary transfer roller 7Y disposed around the photosensitive drum 1Y. The photosensitive drum 1Y is an image carrier that carries an image of a predetermined color (yellow).

The photosensitive drum 1Y is pivotally supported in a rotatable manner. The charging part 2Y is for charging the photosensitive drum 1Y. The surface of the photosensitive drum 1Y is charged by the charging part 2Y to a predetermined charge potential with a negative polarity. A latent image is formed on the photosensitive drum 1Y as a result of scanning and exposure with the optical writing part 3Y.

The developing device 4Y includes a developing roller to which a developing bias voltage is applied. The developing bias voltage has a negative polarity with respect to the ground. Thus, the surface potential of the developing roller (hereinafter referred to as “development potential”) is a predetermined negative voltage. The developing device 4Y turns the latent image on the photosensitive drum 1Y into a visible image by developing the latent image with toner. As a result, an image (toner image) corresponding to yellow is carried on the photosensitive drum 1Y.

The primary transfer roller 7Y is disposed on the inner peripheral surface side of the intermediate transfer belt 6 as a transfer medium in such a way as to face the photosensitive drum 1Y. A primary transfer voltage is applied to the primary transfer roller 7Y to provide a charge with a polarity opposite to the toner to the back side of the intermediate transfer belt 6 (the side in contact with the primary transfer roller 7Y). Thus, the images formed on the photosensitive drum 1Y are sequentially transferred to predetermined positions on the intermediate transfer belt 6. The cleaning device 5Y removes residual toner on the photosensitive drum 1Y.

The same applies to the other image forming parts 10M, 10C, and 10K. The image forming parts 10M, 10C, and 10K include photosensitive drums 1M, 1C, and 1K, and also include charging parts 2M, 2C, and 2K, optical writing parts 3M, 3C, and 3K, developing devices 4M, 4C, and 4K, cleaning devices 5M, 5C, and 5K, and primary transfer rollers 7M, 7C, and 7K disposed around the photosensitive drums 1M, 1C, and 1K, respectively.

A belt cleaning part 8 cleans the surface of the intermediate transfer belt 6 from winch an image has been transferred. The cleaned intermediate transfer belt 6 is used for the next image transfer. The belt cleaning part 8 includes cleaning members such as a brush roller, a blade, and a metal roller.

An image formed with respective colors transferred onto the intermediate transfer bell 6 is transferred by a secondary transfer roller 9 to a paper sheet P conveyed by a paper conveying part 20 at a predetermined timing. The secondary transfer roller 9 is disposed while being pressed against the intermediate transfer belt 6 to form a nip (secondary transfer nip), and transfers the image to the paper sheet P.

The paper conveying part 20 conveys the paper sheet P along a conveying path. The paper sheet P is stored in a paper feed tray 21. The paper sheet P stored in the paper feed tray 21 is brought in a paper feeder 22, and is sent to the conveying path. A plurality of conveyance means for conveying the paper sheet P is provided upstream of the transfer nip in the conveying path. Each conveyance means includes a pair of rollers pressed against each other, and at least one of the rollers is rotationally driven through an electric motor as a driving means. The conveyance means conveys the paper sheet P by rotating while holding the paper sheet P. Note that it is possible to adopt a wide variety of configurations in which the conveyance means includes a pair of rotary members such as a combination of belts or a combination of a belt and a roller, in addition to a configuration in which the conveyance means includes a pair of rollers.

The fixing device 40 is a device that fixes the image transferred to the paper sheet P. The fixing device 40 includes, for example, a fixing roller 41, a pressure roller 42, and a fixing heater 43. The fixing roller 41 and the pressure roller 42 are arranged while being pressed against each other to form a nip (fixing nip). The fixing heater 43 heats the fixing roller 41. The fixing device 40 fixes the image transferred to the paper sheet P by performing pressure fixing by means of the fixing roller 41 and the pressure roller 42 and performing heat fixing by means of the fixing heater 43.

The paper sheet P subjected to the fixing process by the fixing device 40 is discharged by a paper discharge roller 28 to a paper discharge tray 29 attached to an outer side surface of the housing. Additionally, in the case where an image is also formed on the back surface of the paper sheet P, the paper sheet P is conveyed by a switching gate 30 to a reversing roller 31 located below after completion of image formation on the surface of the paper sheet P. The reversing roller 31 reverses the conveyed paper sheet P by sending the paper sheet P in the reverse direction after holding the rear end of the paper sheet P, and feeds the paper sheet P to a paper refeeding conveying path. The paper sheet P fed to the paper refeeding conveying path is conveyed by a plurality of conveyance means for refeeding paper sheets, and is returned to a transfer position.

The controller 50 has a function of integrally controlling the image forming apparatus. A computer, such as a microcomputer, mainly including a central processing unit (CPU), a read-only memory (ROM), a random access memory (RAM), and an input-output (I/O) interface can be used as the controller 50. The controller 50 controls image formation by controlling the image forming parts 10Y, 10M, 10C, and 10K, the fixing device 40, and the like.

In relation to the present embodiment, the controller 50 performs image stabilization control on the four image forming parts 10Y 10M, 10C, and 10K. In the image stabilization control, the levels of parameters of image formation are changed to cause a plurality of patch images to be formed on (transferred to) the intermediate transfer belt 6 (an example of a transfer medium), and the image density (toner adhesion amount) of each of the formed patch images is detected. Then, correction values of the parameters are determined based on the respective image densities of the patch images, and the parameters are corrected according to the correction values. An example of the image stabilization control is to accurately correct the development characteristics of the four image forming parts 10Y, 10M, 10C, and 10K. The parameters of image formation include a development potential, a charge potential, and the like.

The controller 50 receives a detection signal input from a density sensor (density detector) 51 that detects the image density of the patch image formed on the intermediate transfer belt 6. The density sensor 51 includes a light emitting element (not shown) and a light receiving element (not shown). The light emitting element emits light. The light receiving element receives reflection of the light emitted from the light emitting element. When light is emitted from the light emitting element to the intermediate transfer belt 6, the light receiving element detects reflected light from the toner image on the intermediate transfer belt 6. A value of the intensity of the reflected light detected by the light receiving element depends on the image density of the toner image. The density sensor 51 outputs, to the controller 50, a detection signal corresponding to a detection voltage generated in the light receiving element.

Next, an outline of reverse transfer and correction of development characteristics will be described prior to description of image stabilization control (correction of development characteristics) to be performed by the controller 50.

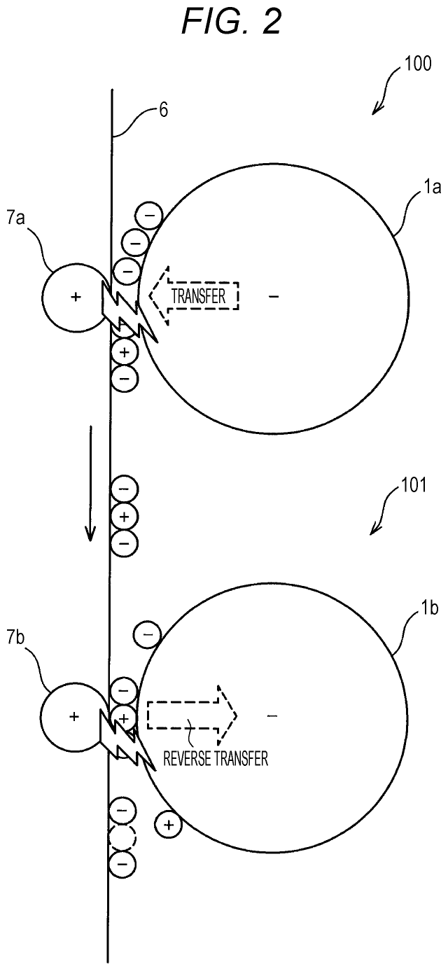

FIG. 2 is an explanatory diagram describing reverse transfer. FIG. 2 shows an upstream image forming part 100 and a downstream image forming part 101. Here, the upstream image forming part 100 and the downstream image forming part 101 conceptually represent an image forming part on the upstream side and an image forming part on the downstream side, respectively, among the four image forming parts 10Y, 10M, 10C, and 10K, as shown in the following examples. For example, in the case where the yellow image forming part 10Y is considered the upstream image forming part 100, the magenta, cyan, and black image forming parts 10M, 10C, and 10K correspond to the downstream image forming part 101. Similarly, in the case where the magenta image forming part 10M is considered the upstream image forming part 100, the cyan and black image forming parts 10C and 10K correspond to the downstream image forming part 101. Furthermore, in the case where the cyan image forming part 10C is considered the upstream image forming part 100, the black image forming part 10K corresponds to the downstream image forming part 101.

Reverse transfer refers to a phenomenon in which when a toner image transferred to the intermediate transfer belt 6 by the upstream image forming part 100 passes through the transfer position of the downstream image forming part 101, the toner image is transferred to a photosensitive drum 1b of the downstream image forming part 101 without staying on the intermediate transfer belt 6.

Specifically, an electric discharge occurs due to the potential difference between a primary transfer roller 7a and a photosensitive drum 1a before and after the transfer position of the upstream image forming part 100, that is, a primary transfer nip between the primary transfer roller 7a and the intermediate transfer belt 6. As a result of the electric discharge, toner on the intermediate transfer belt 6 is weakly charged or reversely charged. When reaching the transfer position of the downstream image forming part 101, the weakly charged or reversely charged toner repels the intermediate transfer belt 6, and is attracted to the photosensitive drum 1b, so that the toner is transferred to the photosensitive drum 1b (reverse transfer).

Generally, the reverse transfer amount of toner varies depending on a transfer voltage (primary transfer voltage), a toner charge amount, the charge potential of the photosensitive drum, and the like, as follows.

As the transfer voltage increases, the potential difference between the primary transfer roller and the photosensitive drum increases, and the amount of electric discharge increases. Therefore, there is a tendency that the amount of weakly charged toner increases and the amount of reverse transfer increases. Furthermore, as the toner charge amount decreases, the amount of weakly charged toner increases when the toner is subjected to an electric discharge. Thus, the amount of reverse transfer tends to increase. In addition, as the charge potential of the photosensitive drum increases, the potential difference between the primary transfer roller and the photosensitive drum increases, and the amount of electric discharge increases. Therefore, there is a tendency that the amount of weakly charged toner increases and the amount of reverse transfer increases. Moreover, the pressure of the primary transfer roller increases, a physical contact force increases. Therefore, there is a tendency that reverse transfer is likely to occur and the amount of reverse transfer increases. In addition, the reverse transfer amount of toner is also affected by the pressure of the primary transfer roller against the intermediate transfer belt and a positional relationship therebetween. The amount of electric discharge changes depending on spatial distance before and after the primary transfer nip. Therefore, the amount of weakly charged toner changes, and the amount of reverse transfer changes.

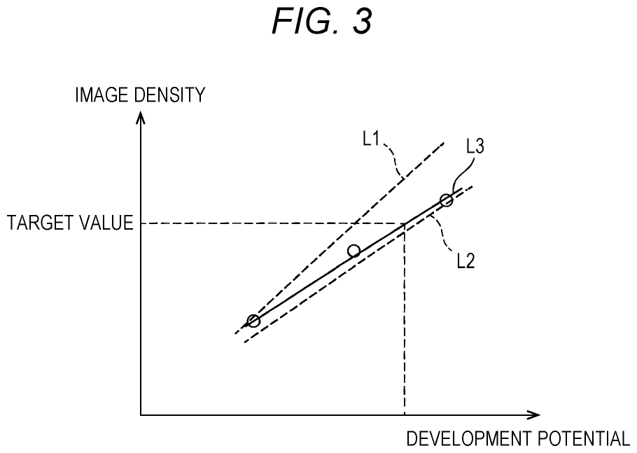

Next, an outline of correction of development characteristics will be described. FIG. 3 is a diagram showing development characteristics (development potential-image density characteristics) of the image forming part. Development characteristics change due to various factors such as a toner charge amount. It is thus necessary to correct development characteristics at an appropriate timing in daily use.

A specific correction operation is as follows. A patch image for correction is formed on (transferred to) the intermediate transfer belt 6. Then, the image density of the patch image is detected, so that correction is made so as to optimize development potential based on the detection result. In this case, a plurality of patch images is formed while changing the level of development potential so as to reduce time and ensure accuracy. In addition, there is generated a first-order approximate expression of a development potential at the time of formation of a patch image and the image density of the patch image. This first-order approximate expression is considered development characteristics. Then, a correction value (optimum value) of development potential is set from the target value of image density by use of the development characteristics. Such correction of development characteristics is performed for each of the four image forming parts 10Y, 10M, 10C, and 10K.

Incidentally, in the correction of development characteristics, charge potential (an example of the parameters of image formation) is also changed together with development potential at the same level so as to avoid causing fogging and carrier adhesion in the developing device (not shown in FIG. 2). Such a change in charge potential causes a change in the amount of reverse transfer at a primary transfer roller 7b in the downstream image forming part 101. In the case where the value of the charge potential in the downstream image forming part 101 is constant over a period in which a patch image of each level formed by the upstream image forming part 100 passes through the primary transfer nip of the downstream image forming part 101, ideal characteristics as shown by dotted lines L1 and L2 in FIG. 3 can be obtained as the development characteristics of the upstream image forming part 100. Here, dotted line L1 indicates development characteristics under a condition where the amount of reverse transfer is small, and dotted line L2 indicates development characteristics under a condition where the amount of reverse transfer is large.

However, in the case where the image forming parts 100 and 101 form a set of patch images, and repeat operation of forming a set of patch images after changing the levels of development potential and the like as in the technique disclosed in JP 2009-300901 A, the charge potential is similarly changed also in the downstream image forming part 101. As a result, the upstream image forming part 100 has development characteristics as shown by solid line L3 in FIG. 3. Thus, correct development characteristics cannot be obtained. In addition, development characteristics are further changed also by a change of the charge potential in the downstream image forming part 101. Therefore, even if the correction value of development potential for the upstream image forming part 100 is determined, the optimum value (correction value) of development potential for the upstream image forming part 100 changes in the case where the charge potential in the downstream image forming part 101 is corrected. Therefore, correction accuracy is reduced.

Meanwhile, in the case where a patch image is formed while the charge potential of the downstream image forming part 101 is kept constant as in the technique disclosed in JP 2006-220848 A, it is possible to obtain ideal development characteristics as shown by dotted lines L1 and L2. However, in this technique, a plurality of patch images is formed after the levels of development potential and the like are changed for a single image forming part, and each image forming part repeats this operation. Therefore, it is necessary to consider time for changing development potential and the like in setting a patch image creation cycle. Thus, time necessary for correcting development characteristics increases. Furthermore, assume the case where a correction value of charge potential determined in the downstream image forming part 101 is different from a charge potential of the downstream image forming part 101 at the time of correction of the upstream image forming part 100. In such a case, there occurs a change in a reverse transfer amount corresponding to the difference in the charge potentials, and correction accuracy is thus reduced.

Therefore, in the correction of development characteristics according to the present embodiment, the level of charge potential in the downstream image forming part 101 is changed in such order that the weighted averages of the charge potentials in the downstream image forming part 101 are discrete with respect to the order in which the level of charge potential is changed in the upstream image forming part 100.

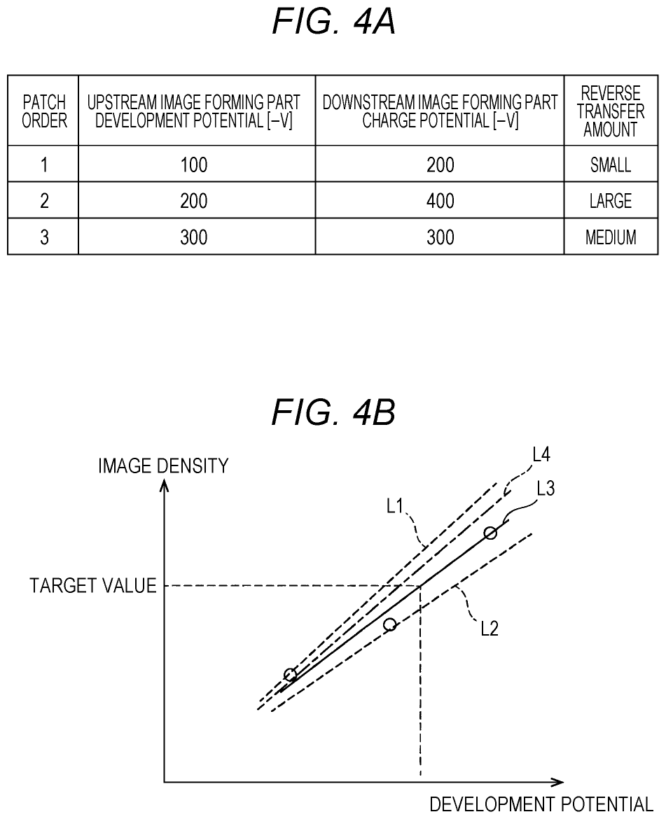

FIGS. 4A and 4B are explanatory diagrams describing correction of development characteristics. FIG. 4A is a diagram showing a relationship between the development potential of the upstream image forming part 100 and the charge potential of the downstream image forming part 101. FIG. 4B is a diagram showing development characteristics.

In the present embodiment, the level of charge potential in the downstream image forming part 101 is changed in such order that the charge potentials in the downstream image forming part 101 are discrete with respect to the order in which the level of development potential is changed in the upstream image forming part 100. For example, in the case where the level of development potential on the upstream side is changed in the order of 100, 200, and 300 [−V], the level of charge potential on the downstream side is changed not in the corresponding order of 200, 300, and 400 [−V], but in the order of 200, 400, and 300 [−V], which is discrete order. In this case, the amount of reverse transfer changes in the order of small, large, and medium. That is, the amount of reverse transfer does not change in a regular order such as small, medium, and large, or large, medium, and small, but changes in a discrete manner. Accordingly, the amount of reverse transfer is absorbed as an approximation error, so that correct development characteristics (slope of the approximate expression) are obtained regardless of the amount of reverse transfer (straight line L3). As a result, correction accuracy can be improved.

Note that as described above, the charge potential is also changed together with the development potential at the same level in correction of development characteristics. Therefore, in the technique described in the present embodiment, the level of development potential and the level of charge potential are changed in the same order in the upstream image forming part 100. That is, the point of the above is equivalent to changing the level of charge potential in the downstream image forming part 101 in such order that the charge potentials in the downstream image forming part 101 are discrete with respect to the order in which the level of charge potential is changed in the upstream image forming part 100.

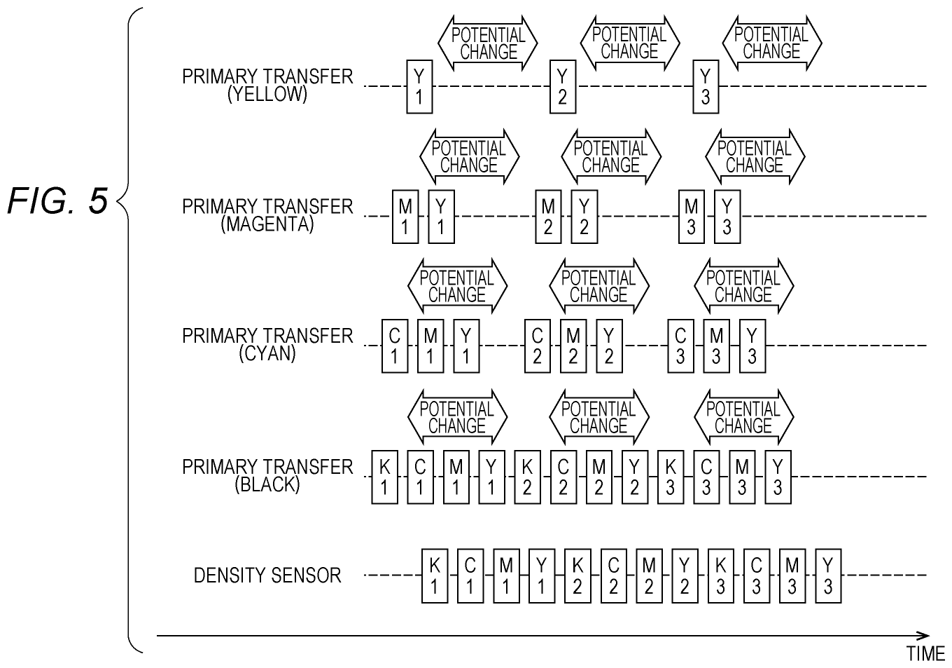

Correction of development characteristics for the four image forming parts 10Y, 10M, 10C, and 10K will be described below. FIG. 5 is an explanatory diagram describing transitions of patch images formed on the intermediate transfer belt 6. Hereinafter, the upstream image forming part is referred to as “upstream image forming parts 10Y, 10M, and 10C,” and the downstream image forming part is referred to as “downstream image forming parts 10M, 10C, and 10K.” Note that the respective upstream image forming parts and downstream image forming parts in the following cases are collectively referred to as the upstream image forming parts 10Y, 10M, and 10C and the downstream image forming parts 10M, 10C, and 10K, respectively: (1) the magenta, cyan, and black image forming parts 10M, 10C, and 10K on the downstream side with respect to the yellow image forming part 10Y on the upstream side, (2) the cyan and black image forming parts 10C and 10K on the downstream side with respect to the magenta image forming part 10M on the upstream side, and (3) the black image forming part 10K on the downstream side with respect to the cyan image forming part 10C on the upstream side.

In the correction of development characteristics according to the present embodiment, there is adopted a technique in which the image forming parts 10Y, 10M, 10C, and 10K form (transfer) patch images in respective colors as a set of patch images in four colors on (to) the intermediate transfer belt 6, and repeatedly form a set of patch images in four colors by changing the levels of development potential and the like. While the potential of each of the four image forming parts 10Y, 10M, 10C, and 10K is changed in the case where the image forming parts 10Y, 10M, 10C, and 10K form a set of patch images in four colors, the rest of the image forming parts 10Y, 10M, 10C, and 10K can form patch images. Therefore, it is possible to reduce time necessary for correcting development characteristics.

Reverse transfer occurs in all the image forming parts 10M, 10C, and 10K on the downstream side. Therefore, the averages of charge potentials of the downstream image forming parts 10M, 10C, and 10K just need to be discretized with respect to the order in which the levels of the upstream image forming parts 10Y, 10M, and 10C are changed. For example, the averages of charge potentials are set as shown in Table 1(a) below. Note that Table 1(b) shows the averages of the charge potentials of the downstream image forming parts 10M, 10C, and 10K with reference to the upstream image forming parts 10Y, 10M, and 10C.

TABLE 1
(a)

| | | | | | Average of charge potentials [-V] of downstream image | | |
|---|---|---|---|---|---|---|---|
| | | | | | forming parts seen from each image forming part | | |
| Patch image | Charge potential [-V] | | | | MCK average | CK average | K |
| order | Y | M | C | K | (downstream of Y) | (downstream of M) | (downstream of C) |
| 1 to 4 | 200 | 400 | 300 | 200 | 300 | 250 | 200 |
| 5 to 8 | 300 | 300 | 400 | 300 | 333 | 350 | 300 |
| 9 to 12 | 400 | 200 | 200 | 400 | 266 | 300 | 400 |

(b)

| | Average of charge potentials [-V] of downstream image | | |
|---|---|---|---|
| Charge potential [-V] | forming parts seen from each image forming part | | |
| of upstream image | (MCK average | CK average | K |
| forming part | downstream of Y) | (downstream of M) | (downstream of C) |
| 200 | 300 | 300 | 400 |
| 300 | 333 | 350 | 200 |
| 400 | 266 | 250 | 300 |

Note that the simple averages of the charge potentials in the downstream image forming parts 10M, 10C, and 10K are used in the example shown in Table 1. However, it is also possible to use the weighted averages of the charge potentials in the downstream image forming parts 10M, 10C, and 10K. In such a case, if each weight is set to “1,” the weighted average can be treated as a simple average.

Furthermore, reverse transfer depends on the amount of weakly charged toner. Accordingly, the amount of reverse transfer increases at a first downstream transfer position where there is a large amount of toner with a low charge amount. Therefore, weights may be assigned to the downstream image forming parts 10M, 10C, and 10K such that a larger weight is assigned to an image forming part located further upstream. In addition, it is also possible to substantially use the charge potential of only one of the downstream image forming parts 10M, 10C, and 10K by setting a weight for a first downstream image forming part to “1” and setting weights for downstream image forming parts located downstream thereof to “0”. It is desirable to experimentally calculate and set the respective weights for the image forming parts 10M, 10C, and 10K.

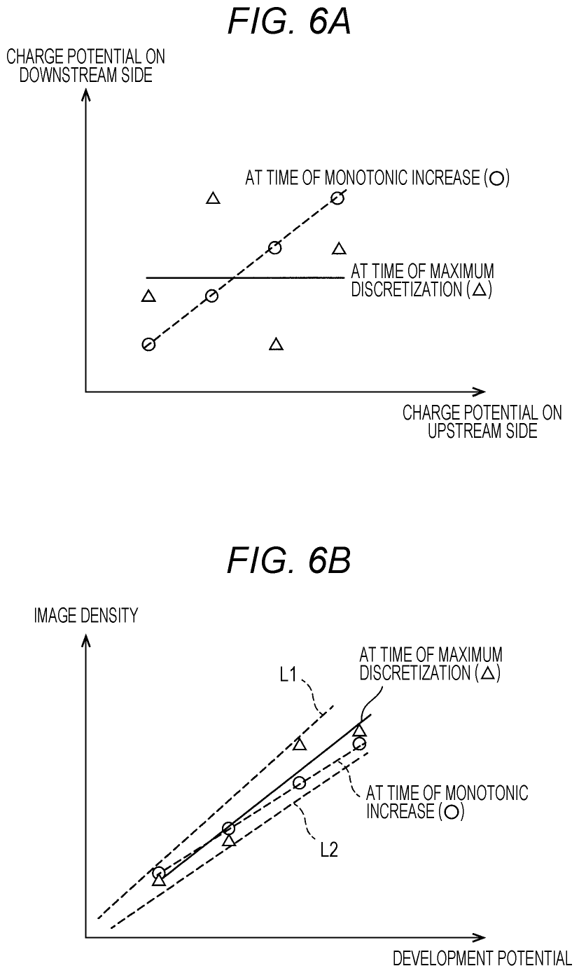

FIGS. 6A and 6B are explanatory diagrams showing discrete relationships. Mutual levels of charge potential just need to be determined in consideration of the number of image forming parts and patch images such that the relationship between the respective levels of charge potential in the upstream image forming parts 10Y, 10M, and 10C and the respective levels of charge potential in the downstream image forming parts 10M, 10C, and 10K is not a monotonic increase or monotonic decrease but there is a discrete relationship between the levels of charge potential in the upstream image forming parts 10Y, 10M, and 10C and the levels of charge potential in the downstream image forming parts 10M, 10C, and 10K.

In this case, the most discrete relationship is obtained when the first-order approximate expression of the respective levels of charge potential in the upstream image forming parts 10Y, 10M, and 10C and the respective levels of charge potential in the downstream image forming parts 10M, 10C, and 10K has a slope of 0 (the absolute value is minimum) as shown in FIG. 6A. Of course, the slope is not limited to 0, and it can be said that the relationship becomes more discrete as the slope of the first-order approximate expression becomes closer to 0. It is possible to obtain appropriate development characteristics as shown in FIG. 6B by changing the levels in a discrete relationship. However, the pattern shown in Table 1 is an example of discretization, and discretization is not necessarily limited to this pattern.

Such a discrete relationship may be determined in advance. Alternatively, the level of charge potential may be redetermined every time development characteristics are corrected. For example, the discrete relationship can be determined by brute-force calculation. Here, Table 2 shows a calculation example regarding four levels of 100 [−V] units. A plurality of combinations may exist, which minimizes the absolute value of the slope as shown in Table 2. In such a case, the same result is obtained by use of any of the combinations.

Note that when a discrete relationship is established between the four image forming parts 10Y, 10M, 10C, and 10K, there is a possibility that the most discrete relationship cannot be achieved depending on the combination. In such a case, among the image forming parts 10Y, 10M, 10C, and 10K, an image forming part to which priority is to be given may be determined to establish a discrete relationship. Alternatively, the discrete quantities of some of the image forming parts may be adjusted in such a way as to optimize the discrete quantities as a whole. For example, priority may be lowered in the order of cyan, magenta, and yellow so that low priority is given to yellow that is less distinguishable when there is a change in color. In addition, if order is determined such that the downstream part of cyan has a slope of 0, yellow may inevitably have a large slope such as 0.8 in some cases. In such a case, adjustments should preferably be made such that the slope of cyan is 0.2 and the slope of yellow is also 0.2. Thus, different approaches are to be preferably taken depending on desired performance.

Furthermore, in the correction of development characteristics according to the present embodiment, correction accuracy is improved by application of the following technique.

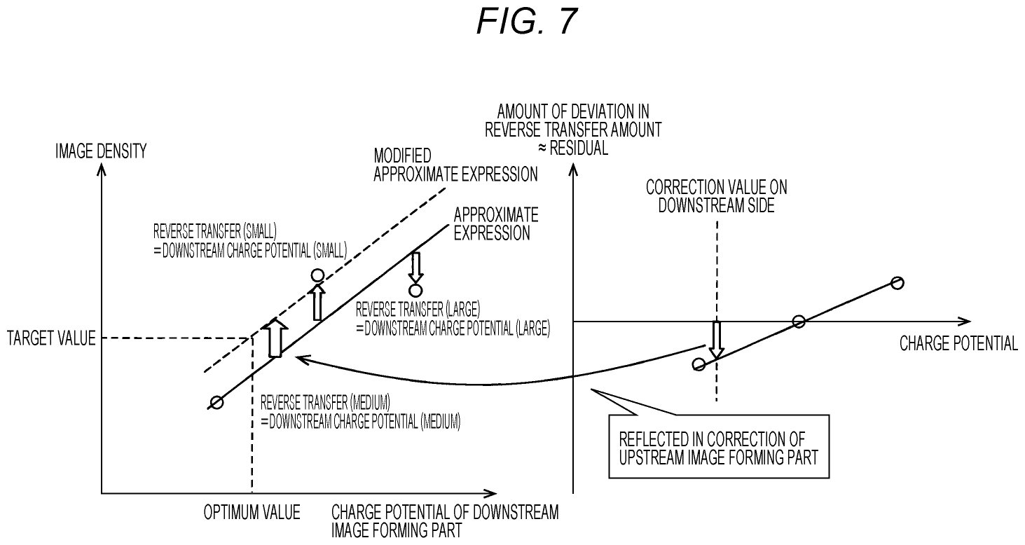

When patch images are formed in a discrete relationship in correction of development characteristics, it is possible to calculate reverse transfer amounts from the results of detection of the patch images and the averages of the charge potentials of the downstream image forming parts 10M, 10C, and 10K. Correction accuracy can be improved by use of the calculated reverse transfer amounts. FIG. 7 is an explanatory diagram showing a concept of calculating a reverse transfer amount from an approximate expression.

As shown on the left side of FIG. 7, the image densities of patch images formed by the upstream image forming parts 10Y, 10M, and 10C are detected to calculate a first-order approximate expression for a relationship between the image densities and the development potentials of the upstream image forming parts 10Y, 10M, and 10C. In this case, residuals, that is, differences between the first-order approximate expression and the image densities can be regarded as reverse transfer amounts if there is no other error such as unevenness in density. In general, an approximate expression is calculated by use of a method (the least squares method) in which subtraction is performed such that the sum of squares of residuals is minimized as a whole. In this case, the average of the charge potentials of the downstream image forming parts 10M, 10C, and 10K and the residual are represented in a graph shown on the right side of FIG. 7.

A residual of 0 here does not mean a reverse transfer amount of 0, but means that the reverse transfer amount corresponds to a value obtained from the first-order approximate expression. In the case where development characteristics are corrected, the charge potentials of the downstream image forming parts 10M, 10C, and 10K are determined based on the results of detection of patch images formed by the downstream image forming parts 10M, 10C, and 10K. Thus, in some cases, there may be differences between the determined charge potentials and charge potentials that cause residuals concerning the first-order approximate expression to be 0. Therefore, as shown on the right side of FIG. 7, the amount of deviation in the reverse transfer amount is calculated from the result of approximate calculation of the charge potentials of the downstream image forming parts 10M, 10C, and 10K and the residuals. Then, the amount of deviation is reflected in correction of the upstream image forming parts 10Y, 10M, and 10C. As a result, it is possible to perform correction while canceling the effect of the amount of reverse transfer.

Specific numerical calculation will be described by use of an example shown in Table 3. As an example, the upstream image forming part is the yellow image forming part 10Y, and the downstream image forming parts are the magenta, cyan, and black image forming parts 10M, 10C, and 10K.

TABLE 3

| | | | | Calculation of difference from | |
|---|---|---|---|---|---|
| | | | Toner adhesion | approximate expression | |
| | Y development | MCK charge | amount detection | Toner adhesion | |
| Patch image | potential [-V] | potential [-V] | result [g/m²] | amount | Residual |
| Y1 | 100 | 300 | 2 | 1.8833 | −0.1167 |
| Y2 | 200 | 333 | 2.8 | 3.0333 | 0.2333 |
| Y3 | 300 | 266 | 4.3 | 4.1833 | −0.1167 |

| | | | |
|---|---|---|---|
| Approximation | Toner adhesion amount = 0.0115 × Y development | MCK optimum | 280 |
| result | potential + 0.7333 | value | |
| | Residual = 0.0052 × MCK charge potential −1.5576 | Y target value | 3 |

| | |
|---|---|
| Y optimum value | 188 |

Yellow patch images were created while the level of development potential was changed in a range from 100 to 300 [−V]. The averages of charge potentials for magenta, cyan, and black patch images created at the same time were 300, 333, and 266 [−V]. At this time, the results of detection of the image densities (toner adhesion amounts) of the yellow patch images were 2, 2.8, and 4.3 [g/m²], respectively.

First, first-order approximation calculation is performed with the development potential (Y development potential) of the yellow image forming part 10Y on the horizontal axis and the result of detection of yellow image density (Y image density) on the vertical axis. Accordingly, the results of the following equations are obtained.

Y image density=0.0115×Y development potential+0.7333 (Equation 1)

An image density for each development potential of the yellow image forming part 10Y is found based on the first-order approximate expression. As a result, a difference between the image density and the detection result is obtained as a residual. In the case of a development potential of 100 [−V], an image density of 1.8833 (=0.0115×100+0.7333) [g/m²] is obtained from the first-order approximate expression. In this case, the residual is −0.1167 (=1.8833−2.0) [g/m²]. Similarly, a residual is calculated for each development potential.

Next, first-order approximation calculation is performed with the average (MCK charge potential) of charge potentials for the magenta, cyan, and black downstream image forming parts 10M, 10C, and 10K on the horizontal axis and a residual on the vertical axis. Accordingly, the results of the following equations are obtained.

Residual=0.0052×MCK charge potential−1.5576 (Equation 2)

Assume that as a result of correction of development characteristics, it has been determined that the optimum value of the MCK charge potential (the average of respective correction values of charge potentials) is 280 [−V] in the magenta, cyan, and black image forming parts 10M, 10C, and 10K. In this case, the residual, that is, the amount of deviation in reverse transfer is −0.1016 (=0.0052×280−1.5576) [g/m²]. The amount of deviation is reflected in correction of the charge potential of the yellow image forming part 10Y located upstream. Specifically, the amount of deviation in reverse transfer is subtracted from the first-order approximate expression of the Y image density shown in Equation 1 (Equation 3).

Y image density=0.0115×Y development potential+0.7333−(−0.1016) (Equation 3)

In the case where the target value of Y image density is 3 [g/m²], the charge potential of the yellow image forming part 10Y is 188 (≈(3−0.7333−0.1016)/0.0115) [−V].

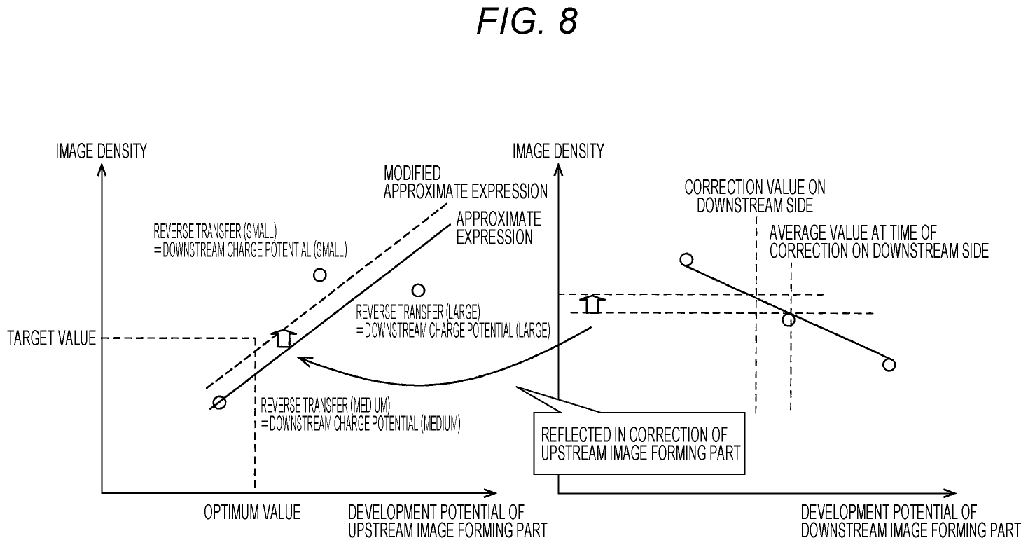

The above are details of estimation of a reverse transfer amount from an approximate expression. Meanwhile, a reverse transfer amount may be measured (measurement mode). Then, it is possible to improved correction accuracy by using the measured reverse transfer amount. FIG. 8 is an explanatory diagram showing a concept of calculating a reverse transfer amount from measurement.

Patch images are formed while the charge potentials of the downstream image forming parts 10M, 10C, and 10K are changed with the development potentials and charge potentials of the upstream image forming parts 10Y, 10M, and 10C maintained at constant values. Then, the image densities of the patch images are detected. Since the development potentials of the upstream image forming parts 10Y, 10M, and 10C are constant, development characteristics do not change. However, the amount of reverse transfer changes depending on changes in the charge potentials of the downstream image forming parts 10M, 10C, and 10K. The amount of reverse transfer increases as the charge potentials of the downstream image forming parts 10M, 10C, and 10K increase. Therefore, the characteristics of the charge potentials of the downstream image forming parts 10M, 10C, and 10K and image density are represented in a graph shown on the right side of FIG. 8. The results of the measurement mode are stored, and when development characteristics are corrected, a difference in image density, that is, the amount of deviation in the reverse transfer amount is calculated from the difference between the average of the charge potentials of the downstream image forming parts 10M, 10C, and 10K at the time of correction and a correction value. The amount of deviation is reflected in correction of the upstream image forming parts. As a result, it is possible to perform correction while canceling the effect of the amount of reverse transfer (see the left side of FIG. 8).

A specific calculation procedure will be described by use of an example shown in Table 4. As an example, the upstream image forming part is the yellow image forming part 10Y, and the downstream image forming parts are the magenta, cyan, and black image forming parts 10M, 10C, and 10K.

TABLE 4
Measurement mode

| | | | Toner adhesion |
|---|---|---|---|
| | Y development | MCK charge | amount detection |
| Patch image | potential [-V] | potential [-V] | result [g/m²] |
| Y′1 | 200 | 200 | 3.2 |
| Y′2 | 200 | 300 | 3.1 |
| Y′3 | 200 | 400 | 2.8 |

| | |
|---|---|
| Approximation | Toner adhesion amount = −0.002 × MCK charge |
| result | potential + 3.6333 |

Image stabilization control

| | | | Toner adhesion |
|---|---|---|---|
| | Y development | Charge potential | amount detection |
| Patch image | potential [-V] | MCK average [-V] | result [g/m²] |
| Y1 | 100 | 300 | 2 |
| Y2 | 200 | 333 | 2.8 |
| Y3 | 300 | 266 | 4.3 |

| | | | |
|---|---|---|---|
| Approximation | Toner adhesion amount = 0.0115 × Y development | MCK optimum | 280 |
| result | potential + 0.7333 | value | |
| | | Y target value | 3 |
| | | Y optimum value | 193 |

For example, operation in the measurement mode is performed as the first task in the morning. Yellow patch images are created while the average of the charge potentials of the magenta, cyan, and black image forming parts 10M, 10C, and 10K is changed in a range from 200 to 400 [−V] in units of 100 [−V] with the development potential and charge potential of the yellow image forming part 10Y maintained at constant values. The results of detection of the image densities of the yellow patch images were 3.2, 3.1, and 2.8 [g/m²], respectively. First-order approximation calculation is performed with the MCK charge potential (average of charge potentials for the magenta, cyan, and black image forming parts 10M, 10C, and 10K) on the horizontal axis and the result of detection of Y image density (yellow image density) on the vertical axis. As a result, a characteristic represented by Equation 4 is obtained. The characteristic is stored as a result of the measurement mode.

Y image density=−0.002×MCK charge potential+3.6333 (Equation 4)

As shown in Table 4, development characteristics are corrected in a discrete relationship. In this case, the average of the MCK charge potentials in the entire correction process is 300 (=(300+333+266)÷3) [−V]. Meanwhile, assume that it has been determined that the optimum value of the NICK charge potential is 280 [−V] directly based on the results of correction of the magenta, cyan, and black image forming parts 10M, 10C, and 10K. The amount of deviation in the reverse transfer amount is found to be −0.04 (=(300−280)×(−0.002)) [g/m²] from the slope of the characteristic (Equation 4) obtained in the measurement mode. This amount of deviation is reflected in correction of the charge potential of the yellow image forming part located upstream. Specifically, the amount of deviation is subtracted from the first-order approximate expression of the Y image density shown in Equation 1 (Equation 5).

Y image density=0.0115×Y development potential+0.7333−(−0.04) (Equation 5)

Accordingly, in the case where the target value of Y image density is 3 [g/m²], the charge potential of the yellow image forming part is 193 (≈(3−0.7333−0.04)/0.0115) [−V].

Reverse transfer amount calculation based on an approximate expression is affected by how an approximate line is drawn with respect to an error. Therefore, accuracy of reverse transfer amount calculation based on an approximate expression is lower than accuracy of reverse transfer amount calculation in the measurement mode. If emphasis is put on correction accuracy, it is preferable to use the measurement mode. However, use of the measurement mode involves an extra patch image forming operation. Therefore, it is desirable to reduce the frequency of activation of the measurement mode as far as possible. The amount of reverse transfer varies depending on the above-described factors. Thus, it is conceivable that changes in the factors in reverse transfer amount variation are individually monitored such that the measurement mode is activated depending on the changes. However, the factors in reverse transfer amount variation are complex. It is thus difficult to accurately set the frequency of activation of the measurement mode. Accordingly, during correction of development characteristics, a reverse transfer amount based on an approximate expression is compared with a reverse transfer amount obtained in the measurement mode. Then, in the case where a difference between the reverse transfer amounts exceeds a threshold value, it is preferable to activate the measurement mode based on the understanding that a variation in the reverse transfer amount based on the approximate expression is larger than a variation in the reverse transfer amount obtained in the measurement mode.

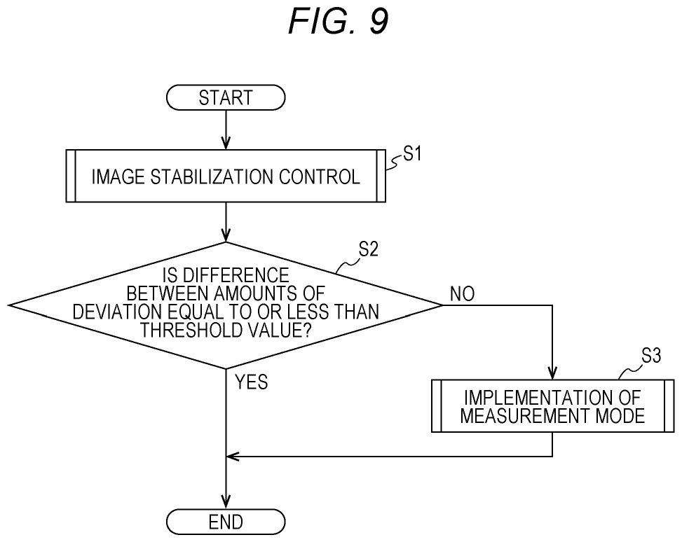

The following describes a method for controlling the image forming apparatus according to the present embodiment. FIG. 9 is a flowchart showing the flow of a process to be performed by the image forming apparatus.

First, in step S1, the controller 50 performs image stabilization control (correction of development characteristics). In the correction of development characteristics, a plurality of patch images is formed while the levels of development potential, charge potential, and the like (hereinafter referred to as “development potential and the like”) are changed. Then, the controller 50 determines development potentials and the like of different levels for forming a plurality of patch images. Furthermore, the controller 50 calculates a patch image forming position corresponding to the development potential and the like of each level. The development potential and the like of each level and the patch image forming position corresponding thereto are calculated for each of the four image forming parts 10Y, 10M, 10C, and 10K.

At this time, the controller 50 sets the levels of development potential and the like in the downstream image forming parts 10M, 10C, and 10K in such order that the weighted averages of charge potentials in the downstream image forming parts 10M, 10C, and 10K are discrete with respect to the order in which the levels of charge potential and the like are changed in the upstream image forming parts 10Y, 10M, and 10C. The development potential and the like of each of the image forming parts 10Y, 10M, 10C, and 10K may be determined in advance. Alternatively, the level of charge potential may be redetermined every time development characteristics are corrected.

The controller 50 controls the four image forming parts 10Y, 10M, 10C, and 10K to form a set of patch images in four colors according to a first level. Furthermore, when a patch image is formed by each of the image forming parts 10Y, 10M, 10C, and 10K, the controller 50 switches the development potential and the like to a second level to form another set of patch images in four colors. The controller 50 repeats this operation.

The respective patch images transferred from the four image forming parts 10Y, 10M, 10C, and 10K to the intermediate transfer belt 6 sequentially reach the density sensor 51 as the intermediate transfer belt 6 runs. As a result, the respective image densities of the patch images are detected by the density sensor 51.

The controller 50 sequentially detects the image densities of the patch images by using the density sensor 51. Then, the controller 50 determines correction values of the respective development potentials and the like of the image forming parts 10Y, 10M, 10C, and 10K based on the detection results, and corrects the development potentials and the like thereof based on the correction values.

At the same time, the controller 50 calculates the amount of deviation in reverse transfer from a first-order approximate expression, based on the results of detection of the image densities of the patch images. At this time, the amount of deviation is reflected in correction of the charge potentials of the upstream image forming parts 10Y, 10M, and 10C.

In step S2, the controller 50 determines whether the difference between the amount of deviation in reverse transfer calculated in the measurement mode and the amount of deviation in reverse transfer calculated from the first-order approximate expression is equal to or less than a threshold value. This threshold value is used to determine whether a variation in the amount of reverse transfer based on the first-order approximate expression is larger than a variation in the amount of reverse transfer at the time of implementation of the measurement mode. An optimum value is set as the threshold value through experiments or simulations.

When the difference between the amounts of deviation is equal to or less than the threshold value, an affirmative determination is made in step S2, and the present routine is terminated. Meanwhile, when the difference between the amounts of deviation is larger than the threshold value, a negative determination is made in step S2, and the process proceeds to step S3.

In step S3, the controller 50 implements the measurement mode. A characteristic calculated by implementation of the measurement mode is stored as a result of the measurement mode. At the same time, the controller 50 reflects the amount of deviation calculated in the measurement mode in correction of the charge potentials of the upstream image forming parts 10M, 10C, and 10K.

As described above, in the image stabilization control (correction of development characteristics) according to the present embodiment, the levels of charge potential in the downstream image forming parts 10M, 10C, and 10K are changed in such order that the weighted averages of charge potentials in the downstream image forming parts 10M, 10C, and 10K are discrete with respect to the order in which the levels of charge potential are changed in the upstream image forming parts 10Y, 10M, and 10C.

According to this configuration, the level of charge potential is changed in a discrete relationship, so that the amount of reverse transfer is also generated irregularly. Accordingly, the amount of reverse transfer is absorbed as an approximation error, and the slope of a correct approximate expression of development characteristics is obtained regardless of the amount of reverse transfer. As a result, the technique according to the present embodiment can improve correction accuracy. In addition, according to this configuration, it is possible to form a set of patch images in four colors. Therefore, correction time can be reduced.

Furthermore, when a weighted average is calculated in the present embodiment, weights may be assigned to the downstream image forming parts 10M, 10C, and 10K such that a weight assigned to an image forming part located further upstream is larger than a weight assigned to an image forming part located further downstream. For example, weights may be assigned to the downstream image forming parts 10M, 10C, and 10K in calculation of a weighted average such that a weight of 1 is assigned to an image forming part located most upstream and a weight of 0 is assigned to image forming parts located downstream thereof.

Reverse transfer depends on the amount of weakly charged toner. Accordingly, the amount of reverse transfer increases at the first downstream transfer position where there is a large amount of toner with a low charge amount. Therefore, according to the configuration of the present embodiment, the effect of reverse transfer can be appropriately reflected in correction of development characteristics.

The order that causes the weighted averages of charge potentials in the downstream image forming parts 10M, 10C, and 10K to be discrete refers to order that causes the relationship between the respective levels of charge potential in the upstream image forming parts 10Y, 10M, and 10C and the respective levels of charge potential in the downstream image forming parts 10M, 10C, and 10K to be a relationship other than a monotonic increase or monotonic decrease. More specifically, the order that causes the weighted averages of charge potentials in the downstream image forming parts 10M, 10C, and 10K to be discrete refers to order that minimizes the absolute value of the slope of a first-order approximate line of the respective levels of charge potential in the upstream image forming parts 10Y, 10M, and 10C and the respective levels of charge potential in the downstream image forming parts 10M, 10C, and 10K.

According to this configuration, a discrete relationship can be set appropriately.

The image forming apparatus according to the present embodiment has been described above. However, the present invention is not limited to the above-described embodiment, and it goes without saying that various modifications are possible within the scope of the invention. In addition, the present invention extends not only to an image forming apparatus but also to a method for controlling an image forming apparatus, and a program.

Furthermore, in the present embodiment, the image forming apparatus has been described based on a configuration in which an intermediate transfer belt is provided to perform primary transfer. Meanwhile, it is also possible to adopt a configuration in which image stabilization control is performed after an image is transferred to a paper sheet through the intermediate transfer belt. In addition, the present invention can also be applied to a method in which an intermediate transfer belt is not provided and an image is directly transferred to a paper sheet. Note that a paper sheet or transfer belt corresponds to a transfer medium in the case of the direct transfer method.

Although embodiments of the present invention have been described and illustrated in detail, the disclosed embodiments are made for purposes of illustration and example only and not limitation. The scope of the present invention should be interpreted by terms of the appended claims.

What is claimed is:

1. An image forming apparatus in which an image carrier with a charged surface is developed with toner to cause a toner image to be carried on the image carrier and the toner image is transferred from the image carrier to a transfer medium, the image forming apparatus comprising:
a plurality of image forming parts each of which transfers a toner image to the transfer medium, the plurality of image forming parts being arranged from an upstream side to a downstream side along a moving direction of the transfer medium;
a density detector that detects a density of the toner image; and
a hardware processor that performs image stabilization control in which a plurality of patch images is formed while levels of parameters of image formation are changed for each of the image forming parts and the parameters are corrected based on respective densities of the patch images detected by the density detector,
wherein the parameters include a charge potential, and
in the image stabilization control, a level of charge potential in a downstream image forming part is changed in such order that weighted averages of charge potentials in the downstream image forming part are discrete with respect to order in which a level of charge potential is changed in a upstream image forming part.

2. The image forming apparatus according claim 1, wherein
the downstream image forming part includes a plurality of image forming parts, and
weights are assigned to the plurality of image forming parts in calculation of the weighted averages such that a weight assigned to an image forming part located further upstream is larger than a weight assigned to an image forming part located further downstream.

3. The image forming apparatus according to claim 1, wherein
the downstream image forming part includes a plurality of image forming parts, and
weights are assigned to the plurality of image forming parts in calculation of the weighted averages such that a weight of 1 is assigned to an image forming part located most upstream and a weight of 0 is assigned to an image forming part located downstream thereof.

4. The image forming apparatus according to claim 1, wherein
the order that causes the weighted averages of the charge potentials in the downstream image forming part to be discrete refers to order that causes a relationship between respective levels of charge potential in the upstream image forming part and respective levels of charge potential in the downstream image forming part to be a relationship other than a monotonic increase or monotonic decrease.

5. The image forming apparatus according to claim 1, wherein
the order that causes the weighted averages of the charge potentials in the downstream image forming part to be discrete refers to order that causes an absolute value of a slope of a first-order approximate line of respective levels of charge potential in the upstream image forming part and respective levels of charge potential in the downstream image forming part to approach 0.

6. The image forming apparatus according to claim 1, wherein
the hardware processor calculates reverse transfer amounts based on the respective densities of the patch images formed in the image stabilization control, and corrects correction values of the image stabilization control, based on the calculated reverse transfer amounts.

7. The image forming apparatus according to claim 1, wherein
the hardware processor forms a plurality of measurement patch images, measures reverse transfer amounts based on respective densities of the measurement patch images, and corrects correction values of the image stabilization control, based on the measured reverse transfer amounts.

8. The image forming apparatus according to claim 1, wherein
the image forming apparatus has:
a first mode in which reverse transfer amounts are calculated based on the respective densities of the patch images formed in the image stabilization control and correction values of the image stabilization control are corrected based on the calculated reverse transfer amounts; and
a second mode in which a plurality of measurement patch images is formed, reverse transfer amounts are measured based on respective densities of the measurement patch images, and the correction values of the image stabilization control are corrected based on the measured reverse transfer amounts, and
the hardware processor implements the second mode in a case where a difference between a calculation result in the first mode and a calculation result in the second mode becomes equal to or greater than a threshold value while the first mode is implemented in conjunction with the image stabilization control.

9. A method for controlling an image forming apparatus in which an image carrier with a charged surface is developed with toner to cause a toner image to be carried on the image carrier and the toner image is transferred from the image carrier to a transfer medium, wherein
the image forming apparatus includes:
a plurality of image forming parts each of which transfers a toner image to the transfer medium, the plurality of image forming parts being arranged from an upstream side to a downstream side along a moving direction of the transfer medium; and
a density detector that detects a density of the toner image,
the method comprises
performing image stabilization control in which a plurality of patch images is formed while levels of parameters of image formation are changed for each of the image forming parts and the parameters are corrected based on respective densities of the patch images detected by the density detector,
the parameters include a charge potential, and
in the performing image stabilization control, a level of charge potential in a downstream image forming part is changed in such order that weighted averages of charge potentials in the downstream image forming part are discrete with respect to order in which a level of charge potential is changed in a upstream image forming part.

10. A non-transitory recording medium storing a computer readable program causing a computer that controls an image forming apparatus to perform the method for controlling the image forming apparatus according to claim 9.
